(19) United States
(12) Patent Application Publication
(10) Pub. No.: US 2007/0026868 A1
(43) Pub. Date: Feb. 1, 2007

(54) Licensed/unlicensed frequency management in a wireless wide-area network

(76) Inventors: Gary D. Schulz, Cary, IL (US); Anthony Kobrinetz, Hoffman Estates, IL (US); Paul Odlyzko, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/190,147

(22) Filed: Jul. 26, 2005

(51) Int. Cl. H04M 3/00; H04Q 7/20

(52) U.S. Cl. 455/454; 455/450

(57) ABSTRACT

A system and method for managing licensed and unlicensed frequency bands in a wireless wide-area network includes establishing the available channels of a licensed band and unlicensed band of frequencies. Data traffic is prioritized for assigning channels. Higher priority data traffic is assigned to the licensed frequency band and lower priority data traffic is assigned to the unlicensed frequency band. Channel quality is determined, wherein higher priority traffic is assigned to lower noise channels. Data traffic is shifted from the channels of the unlicensed frequency band to the channels of the licensed frequency band if the quality of the channels of the unlicensed frequency band deteriorates below a predetermined acceptable threshold.

### FIELD OF THE INVENTION

The present invention relates generally to the field of communication systems, and more particularly, to wireless wide-are networks operable on licensed or unlicensed frequency bands.

### BACKGROUND OF THE INVENTION

Wireless wide-area networks, such as Motorola's Canopy™ system, operate on unlicensed frequency bands. Due to the unlicensed nature of the frequency spectrum, anyone is able to use the available bandwidth, in any amount, and at any time. As a result, the quality of service can not be guaranteed for subscribers. One solution to this problem is newly licensed frequency bands (e.g. a given spectral allocation), wherein only service providers who have paid for the license can use these licensed bands for their subscribers. As a result, the service provider can control this spectrum to guarantee a particular quality of service for their subscribers.

However, there are still problems in licensed services. Firstly, there is only a limited amount of licensed bandwidth available, which can only accommodate a limited number of subscribers at one time. Secondly, accommodating a large number of subscribers, even within the licensed band, can deteriorate a quality of service (QoS) for those subscribers sharing the licensed bandwidth. Moreover, existing frequency management systems only act in such a way to manage frequencies/channelizations within a given spectral allocation. They may manage or change parameters of control channels, but they cannot be used to gain additional system capacity.

What is needed is a system and method for a service operator to apparently oversubscribe their licensed bandwidth by leveraging available unlicensed bandwidth. It would also be of benefit to manage licensed and unlicensed bandwidths to provide greater spectral efficiencies.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a simplified block diagram for a system, in accordance with the present invention;

FIG. 2 shows an example of frequency bands that can be utilized by the system of FIG. 1; and

FIG. 3 shows a flow chart of a method, in accordance with the present invention.

### DETAILED DESCRIPTION OF THE PREFERRED EMBODIMENT

The present invention provides a system and method for a service operator to apparently oversubscribe their licensed bandwidth by leveraging available unlicensed bandwidth to enhance the perception of greater aggregate bandwidth available for user traffic. The present invention also manages licensed and unlicensed bandwidths to provide greater spectral efficiencies and gain additional system capacity. The present invention finds specific application in wide area networks, such as Motorola's Canopy™ system for example, and can be applied in both the current Frequency Shift Keying (FSK) platform as well as the newly developing licensed Orthogonal Frequency Division Multiplexing (OFDM) system.

In particular, the present invention provides an improved Media Access Control (MAC) that can provide greater spectral efficiencies by prioritizing data traffic by QoS in such a way that it can guarantee low latency (i.e. low interference) to high priority traffic and allow lower priority traffic to occupy unlicensed frequencies that are convenient for the physical layer. For example, such a system can use one or two channels in the U.S. Multimedia Multipoint Distribution Service (MMDS) allocation at 2.5 GHz and at the same time route the majority of the traffic burden to the unlicensed 2.4 GHz Industrial Scientific Medical (ISM) band which is adjacent thereto (see FIG. 2). On a statistical basis at any given time, the unlicensed spectrum should be adequately noise and interference free to take the majority of the traffic load. As noise and interference conditions worsen, the priority traffic can be shifted to the licensed spectrum for guaranteed delivery. This allows the licensee of relatively scarce and valuable licensed spectrum to offer a system with many times the system capacity by intelligently routing traffic to relatively plentiful (and free) unlicensed spectrum.

The present invention can be viewed as a frequency domain oversubscription mechanism. The operator in this case can realize a system with greater than eight-times system capacity making one 6 MHz licensed channel appear as 50 MHz of spectrum. As shown in FIG. 2 for example, a service operator may have licensed spectrum in the Wireless Communication Services (WCS) band at 2285 MHz, or the Instructional Fixed Television Service/Multimedia Multipoint Distribution Service (ITFS/MMDS) band at 2500 MHz for traffic requiring higher quality channels. The present invention provides the service operator the opportunity to use the unlicensed Industrial Scientific Medical (ISM) band at 2400 MHz for traffic that can accommodate lower quality channels, and to shift traffic between licensed and unlicensed bands as quality changes. Although the available bands around 2285 to 2684 MHz are shown, it should be recognized that the present invention is applicable to licensed and unlicensed bands at any frequency, even where the licensed and unlicensed bands are not close to each other in frequency.

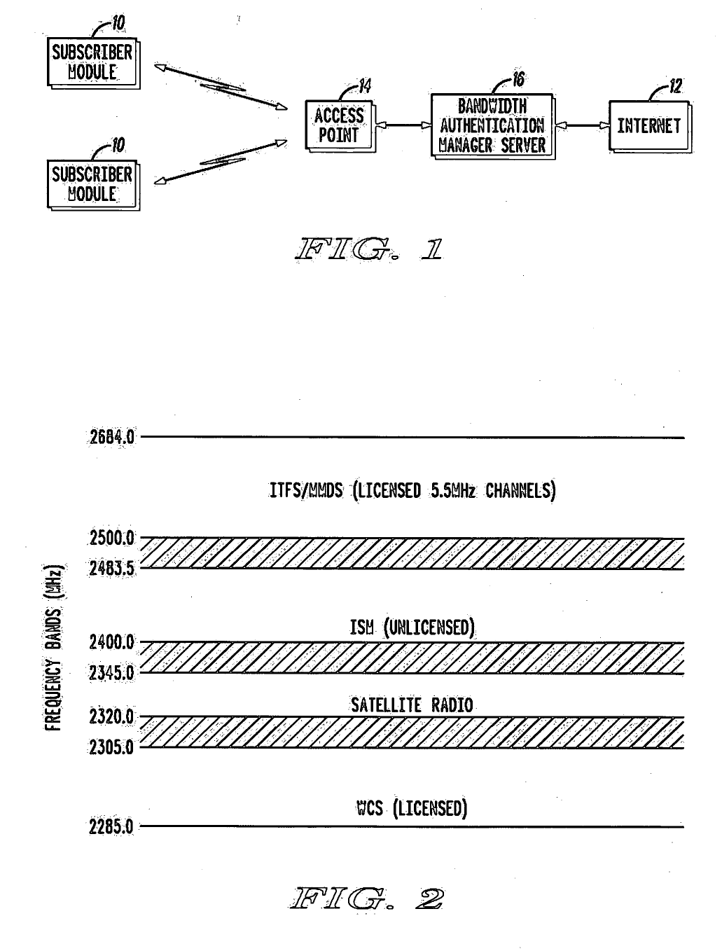

Referring back to FIG. 1, a wide area network, such as the Motorola's Canopy™ system utilizes one or more access points (AP) 14 (one shown) that services a plurality of subscriber modules (SM) 10 within a sector. The access point 14 functions similarly to a base station, and the subscriber module functions similarly to a mobile radiotelephone, in a cellular communication system. Other access points (not shown) service other subscriber modules (also not shown) in other sectors. For example, six access points could be co-located at a single site, with each access point serving a generally sixty-degree area (sector) of a hexagonal region surrounding the site. Each access point can service up to two-hundred subscriber modules in its sector. A Bandwidth Authentication Manager (BAM) server 16 provides an Internet Protocol (IP) pipe from the Internet 12 to each access point 14, as is known in the art, for transferring information with subscriber modules. This connection can be wired or wireless.

Each access point 14 includes a wireless physical layer as part of its protocol stack to communicate with its assigned subscriber modules 10. The protocol stack also includes a Media Access Controller (MAC) layer. The MAC layer tracks the quality of an RF link to a subscribe module and also manages that link. Various quality metrics are known in the art and can include a measure of signal strength, signal-to-noise ratio (SNR), energy per bit, interference, and the success of sending packet data, among others, that can be generally grouped under the term Quality of Service (QoS). The protocol stack can also include Transport Control Protocol/Internet Protocol (TCP/IP) layers and an application layer to drive communications between the access point 14, BAM 16, and the subscriber modules 10. At present, the system uses a Time Division Duplex (TDD) communication system. However, it should be recognized that the present invention is applicable to any communication system, such as the newly developing licensed Orthogonal Frequency Division Multiplexing (OFDM) system.

In operation, the AP broadcasts downlink frames that contain control information, allocating slots in succeeding or future uplink frames to subscriber modules that have requested service. Each SM examines the downlink frame to distinguish whether data is addressed thereto, and retrieves data address to that SM. Uplink frames contain control information from each SM that request service on succeeding uplink frames. SMs insert data into the frames in an amount that the AP has established. When an SM boots up, the SM synchronizes with the AP. If Bandwidth Authentication Management is configured in the AP protocol stack, and the AP is licensed for authentication, the AP sends a Registration Request message to the BAM server 16 for authentication. Following a successful challenge, the BAM server 16 returns an Authentication Grant message to the AP, and the AP sends a Registration Grant message to the SM, setting up the IP address of the SM for communicating with the Internet 12.

At present, the MAC layer of the protocol stack of the AP reserves TDD slots for each SM that request services and tracks the quality of service (QoS) of the communication. In one embodiment of the present invention, the MAC also controls what frequency channels are used by the SM, including licensed and unlicensed spectrum, such as for an Orthogonal Frequency Division Multiplexing (OFDM) system, as will be detailed below. The AP uses four QoS parameters for bandwidth management; a) sustained uplink data rate, b) uplink burst allocation, c) sustained downlink data rate, b) downlink burst allocation, all of which can be independently set per AP or SM. Normally, the date rate varies by the quality of the channel. However, the amount of data is capped at a Maximum Information Rate (MIR). In addition, there may be up to two-hundred SMs requesting service with the AP, which only has limited licensed bandwidth resources. As a result, quality can suffer given a limited licensed bandwidth, and service can not be guaranteed.

Channel quality is dynamically adaptive per data rate and depends upon the communication type. For example, normal web-browsing, e-mail, small file transfers, and short streaming video normally do not present quality or rate problems with practical bandwidth management (QoS) settings in the AP or BAM. However, when the SM processes large downloads such as software upgrades or long streaming video, the burst limit is reached and some packets are delayed (i.e. latency). Therefore, problems can occur when supporting low-latency tolerant traffic such as Voice over Internet Protocol (VoIP) or video.

The present invention solves this problem by providing a method of managing licensed and unlicensed frequency bands, wherein the MAC of the AP establishes available channels of a licensed band of frequencies and available channels of an unlicensed band of frequencies. The MAC then prioritizes data traffic according to data type and subscriber need, and assigns higher priority data traffic to the channels of the licensed band of frequencies and lower priority data traffic to the channels of the unlicensed band of frequencies. In particular, the MAC determines an amount of noise and/or interference in each channel, and assigns higher priority data traffic to lower noise and/or interference channels. Specifically, the MAC determines a Quality of Service (QoS) value for each channel, and assigns higher priority data traffic to channels with a higher QoS.

It should be noted that with the licensed channel(s) there is no assurance that bandwidth is actually available, as it is possible that a subscriber device is (perhaps temporarily) located where there is good coverage from the access points using license-exempt spectrum (e.g. via Wi-Fi installed by the same operator, or a “friendly” unlicensed system with which there is an agreement) but where the operator has not installed their licensed-spectrum infrastructure. In such a case the license-exempt band is better, if not the only one.

A higher priority can be assigned to traffic that has low latency-tolerance, or for subscribers who pay a higher fee, over traffic that is latency-tolerant such as standard web traffic and file downloads. The AP prioritizes traffic for relatively low noise licensed spectrum in its high priority queue according to AP configuration settings for the licensed band. Traffic deemed of a lower priority is queued for the relatively higher noise/interference channels of the unlicensed spectrum. The system sends the priority packets on the licensed band and services this licensed band before any normal, lower priority traffic on the unlicensed band.

In a preferred embodiment, the present invention also maintains a higher quality of service on channels of the licensed frequency band than channels of the unlicensed frequency band. In particular, the present invention shifts data traffic from the channels of the unlicensed frequency band to the channels of the licensed frequency band if the quality of the channels of the unlicensed frequency band deteriorates below a predetermined acceptable threshold or if the quality of the licensed bands is sufficient to accommodate more traffic. Similarly, data traffic can be shifted from the channels of the licensed frequency band to the channels of the unlicensed frequency band if the quality of the channels of the unlicensed frequency band improves above the predetermined acceptable threshold or if the quality of the licensed bands is insufficient to accommodate the existing traffic. The threshold for shifting traffic between the licensed and unlicensed bands is a measure of channel quality, and is dynamically adjusted depending upon a QoS (e.g. latency) of traffic data channels. The channel quality and threshold can be determined in real time or can be determined statistically, over preceding time windows for example.

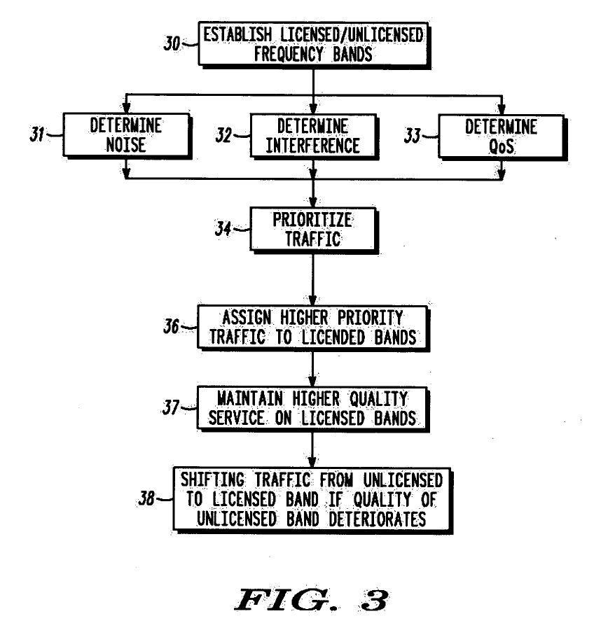

Referring to FIG. 3, the present invention also includes a method of managing licensed and unlicensed frequency bands. The method includes a first step 30 of establishing available channels of a licensed band of frequencies and available channels of an unlicensed band of frequencies. Next steps 31, 32, 33 include determining one or more of; amount of noise, and amount of interference, and a QoS for each channel. A next step 34 includes prioritizing data traffic. A next step 36 includes assigning higher priority data traffic to the channels of the licensed band of frequencies and lower priority data traffic to the channels of the unlicensed band of frequencies. In particular, this step includes assigning higher priority data traffic to channels with lower noise, interference, and/or QoS.

In a preferred embodiment, a further step 37 includes maintaining a higher quality of service on channels of the licensed frequency band than channels of the unlicensed frequency band. More preferably, a further step 38 is included for shifting data traffic from the channels of the unlicensed frequency band to the channels of the licensed frequency band if the quality of the channels of the unlicensed frequency band deteriorates below a predetermined acceptable threshold. Threshold can be a measure of channel quality, which is dynamically adjusted depending upon a latency of traffic data.

The present invention can solve the problem of service operators who are reticent to develop wireless networks because they have no control over the interference prone environment in unlicensed spectrum. Such operators do not want to make an investment in deploying equipment that at some point could be rendered less useful by interference. In this case, those operators with relatively modest investments in licensed channels can offer service that leverages a huge amount of spectrum and yet provides sufficient security (interference immunity) for “important” traffic. As a result, the present invention can make a small amount of licensed spectrum seem like a very large amount of licensed spectrum.

While the invention may be susceptible to various modifications and alternative forms, a specific embodiment has been shown by way of example in the drawings and has been described in detail herein. However, it should be understood that the invention is not intended to be limited to the particular forms disclosed, and can be applied equally well to any communication system that can use licensed and unlicensed frequency bands. Rather, the invention is to cover all modification, equivalents and alternatives falling within the scope of the invention as defined by the following appended claims.

1. (canceled)

2. The method of claim 9, wherein the channel quality in the step of determining is an amount of noise in each channel.

3. The method of claim 9, wherein the channel quality in the step of determining is an amount of interference in each channel.

4. The method of claim 9, wherein the channel quality in the step of determining is a Quality of Service (QoS) value for each channel.

5. (canceled)

6. The method of claim 9, wherein the step of shifting includes shifting existing data traffic from the channels of an unlicensed frequency band to the channels of a licensed frequency band if the quality of the channels of the licensed bands is sufficient to accommodate more traffic.

7. The method of claim 9, wherein the step of shifting includes shifting existing data traffic from the channels of a licensed frequency band to the channels of an unlicensed frequency band if the quality of the channels of the unlicensed frequency band improves above a predetermined acceptable threshold.

8. The method of claim 7, wherein the step of shifting includes shifting data traffic from the channels of the licensed frequency band to the channels of the unlicensed frequency band if the quality of the channels of the licensed bands is insufficient to accommodate the existing traffic.

9. In a wireless wide-area network, a method of managing licensed and unlicensed frequency bands comprising the steps of:
establishing available channels of a licensed frequency band and available channels of an unlicensed frequency band;
prioritizing data traffic;
determining a channel quality for each channel;
assigning higher priority data traffic to the channels of a higher channel quality and lower priority data traffic to the channels of a lower channel quality; and
shifting existing data traffic from the channels of the lower channel quality to the channels of the higher channel quality if the quality of the channels of the data traffic deteriorates below a predetermined acceptable threshold of channel quality.

10. The method of claim 9, wherein the shifting step includes shifting data traffic from the channels of the unlicensed frequency band to the channels of the licensed frequency band if the quality of the channels of the unlicensed frequency band deteriorates below a predetermined acceptable threshold of channel quality.

11. The method of claim 10, wherein the threshold is dynamically adjusted depending upon a latency of traffic data.

12. The method of claim 9, wherein the establishing step includes the licensed frequency band has a narrower bandwidth than the unlicensed frequency band.

13. The method of claim 9, wherein secure data traffic is limited to the licensed frequency band.

14. A wireless wide-area network operable on licensed and unlicensed frequency bands, the network comprising:
a media access controller that establishes available channels of a licensed band of frequencies spectrum and available channels of an unlicensed band of frequencies, prioritizes data traffic, determines a channel quality for each channel, assigns higher priority data traffic to the channels of the licensed band of frequencies and lower priority data traffic to the channels of the unlicensed band of frequencies, and shifts existing data traffic from the channels of the unlicensed band of frequencies to the channels of the licensed band of frequencies if the quality of the channels of the data traffic deteriorates below a predetermined acceptable threshold of channel quality.

15. The network of claim 14, wherein the media access controller determines an amount of noise in each channel and assigns higher priority data traffic to lower noise channels.

16. The network of claim 14, wherein the media access controller determines an amount of interference in each channel and assigns higher priority data traffic to lower interference channels.

17. The network of claim 14, wherein the media access controller determines a Quality of Service (QoS) value for each channel and assigns higher priority data traffic to higher QoS channels.

18. The network of claim 14, wherein the media access controller shifts existing data traffic from the channels of the unlicensed frequency band to the channels of the licensed frequency band if the quality of the channels of the licensed bands is sufficient to accommodate more traffic.

19. The network of claim 14, wherein the threshold is dynamically adjusted depending upon a latency of traffic data.

20. The network of claim 14, wherein the media access controller maintains a higher quality of service on channels of the licensed frequency band than channels of the unlicensed frequency band.
